(19) United States
(12) Patent Application Publication
(10) Pub. No.: US 2026/0110895 A1
(43) Pub. Date: Apr. 23, 2026

(54) HEAD-MOUNTED DISPLAY

(71) Applicant: Sony Interactive Entertainment Inc., Tokyo (JP)

(72) Inventors: Shotaro Tada, Aichi (JP); Yasutoshi Katsuda, Kanagawa (JP)

(73) Assignee: Sony Interactive Entertainment Inc., Tokyo (JP)

(21) Appl. No.: 19/423,864

(22) Filed: Dec. 17, 2025

Related U.S. Application Data
(63) Continuation of application No. PCT/JP2023/024518, filed on Jun. 30, 2023.

(51) Int. Cl. G02B 25/00; G02B 23/18; G06F 1/16

(52) U.S. Cl. CPC G02B 25/001; G02B 23/18; G06F 1/163

(57) ABSTRACT

A head-mounted display (1) worn on the head of a user (U), including: an eyepiece lens (100) positioned in front of the eye of the user (U) in the state wherein the user (U) is wearing the head-mounted display (1); a display panel (10) including at least a first display area for displaying a first image and a second display area for displaying a second image non-contiguously from the first image; a first lens portion (20) for guiding first image light exiting the first display area to the eyepiece lens (100) and enlarging the first image for the user (U) to view; and a second lens portion (20) for guiding second image light exiting the second display area to the eyepiece lens (100) and enlarging the second image for the user (U) to view.

### TECHNICAL FIELD

The present disclosure relates to a head-mounted display.

### BACKGROUND OF THE INVENTION

Conventionally, as shown by Patent Document 1, head-mounted displays having a display panel for displaying an image as well as an optical system which includes a lens are known.
[Patent Document 1] International Publication No. WO 2016/136657

### BRIEF SUMMARY OF THE INVENTION

### Problem to be Solved by Invention

In a head-mounted display, improved visibility of a displayed image is required for an enhanced sense of immersion.

One object of the present disclosure is to provide a head-mounted display possessing high visibility.

### Means for Solving Problem

The head-mounted display proposed in the present disclosure is a head-mounted display worn on the head of a user, including: an eyepiece lens positioned in front of the eye of the user in the state wherein the user is wearing the head-mounted display; a display panel including at least a first display area for displaying a first image and a second display area for displaying a second image non-contiguously from the first image; a first lens portion for guiding first image light exiting the first display area to the eyepiece lens and enlarging the first image for the user to observe; and a second lens portion for guiding second image light exiting the second display area to the eyepiece lens and enlarging the second image for the user to observe.

### BRIEF DESCRIPTION OF THE DRAWINGS

FIG. 1A is a perspective view of an HMD according to the present embodiment as seen from the front left.

FIG. 1B is a left side view of the HMD according to the present embodiment as seen from the left.

FIG. 2 is a diagram schematically illustrating a configuration of the display panel and the optical system of the present embodiment.

FIG. 3 is a plan view illustrating the display panel of the present embodiment as seen from the front.

FIG. 4A is a diagram illustrating one example of a display image when a lattice form is displayed in each display area.

FIG. 4B is a diagram illustrating one example of a display image when a circular object is displayed.

FIG. 5A is a diagram illustrating one example of a display image which is visible to a user through a lens portion when a lattice form is displayed in each display area.

FIG. 5B is a diagram illustrating one example of a display image which is visible to a user through a lens portion when a circular object is displayed.

FIG. 6 is a diagram illustrating the display panel of a first variation.

FIG. 7 is a diagram illustrating the display panel of a second variation.

### DETAILED DESCRIPTION OF THE INVENTION

### Embodiments of Invention

Hereinafter, an embodiment of the present invention (hereinafter, referred to as the present embodiment) will be described with reference to the drawings. In the following description, a head-mounted display 1 is referred to as an “HMD (head-mounted display) 1”. Additionally, in the following description, the directions indicated by X1 and X2 in the drawings are to the right and left, respectively, the directions indicated by Y1 and Y2 in the drawings are upward and downward, respectively, and the directions indicated by Z1 and Z2 in the drawings are frontward and backward, respectively. Each of these directions indicates a direction as seen by a user wearing the HMD 1. The left-right, up-down, and front-back directions do not, however, indicate strict directions.

### Overview of HMD 1

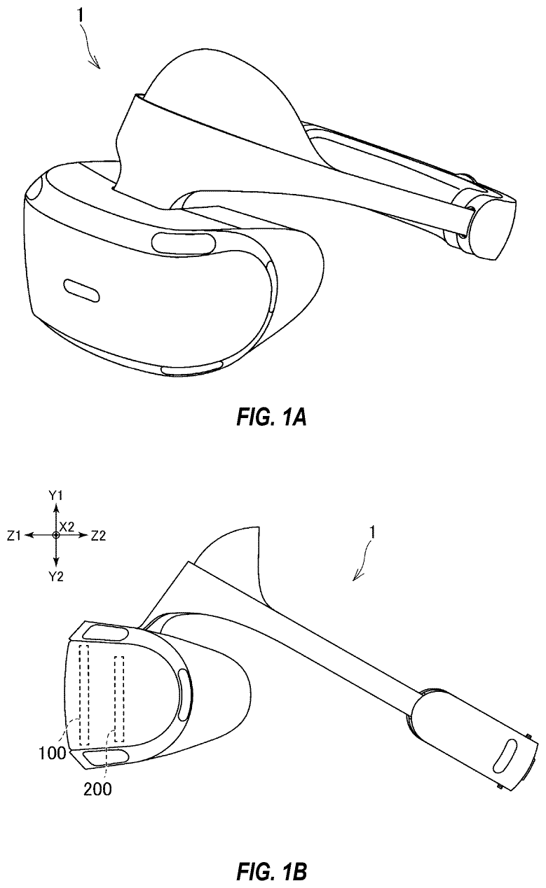

FIG. 1A is a perspective view of an HMD according to the present embodiment as seen from the front left. FIG. 1B a left side view of the HMD according to the present embodiment as seen from the left. Note that in the following description, the state in which the HMD 1 is being worn by the user is referred to as a “utilized state”. In the utilized state, the eyes of the user are covered by the HMD 1.

The HMD 1 may have a mounting band that goes around the head of the user, and a main body housing that is supported by a front portion of the mounting band. The main body housing contains a display unit 100 and various components, such as an eyepiece lens 200, constituting an optical system.

The display unit 100 includes a display panel 10 which will be described later. A display panel 10 may acceptably display a two-dimensional or three-dimensional image. The display panel 10 may be, for example, a liquid crystal display or an organic electroluminescence display device, however, there is no particular limitation in terms of type.

The HMD 1 illustrated in FIGS. 1A and 1B is one example, and is not limited thereto. The HMD 1 is worn at least on the head of the user, may be provided with a display panel for displaying an image, and is not limited to the forms illustrated in the drawings for the mounting band, main body housing, and the like. In addition, in FIG. 1B, the display unit 100 and the eyepiece lens 200 are represented schematically, and the forms and sizes thereof are not limited to those illustrated in the drawings.

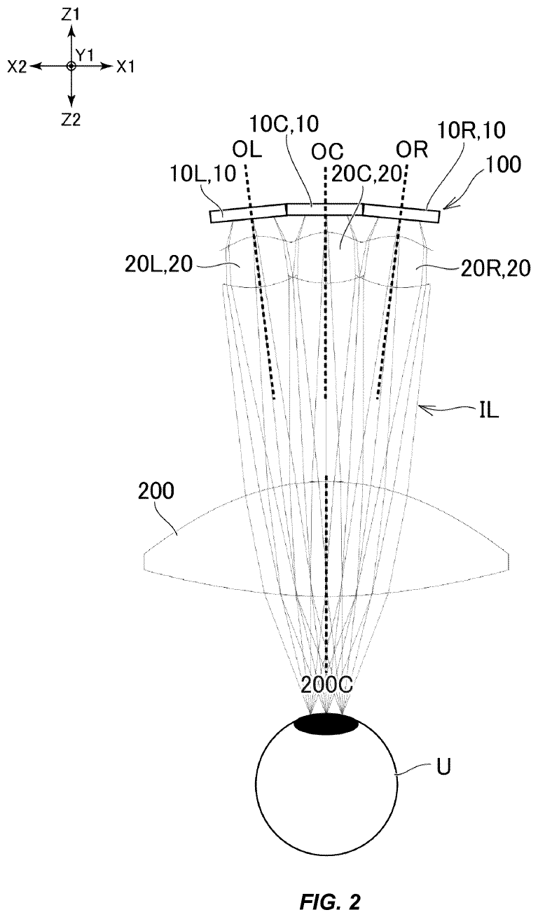

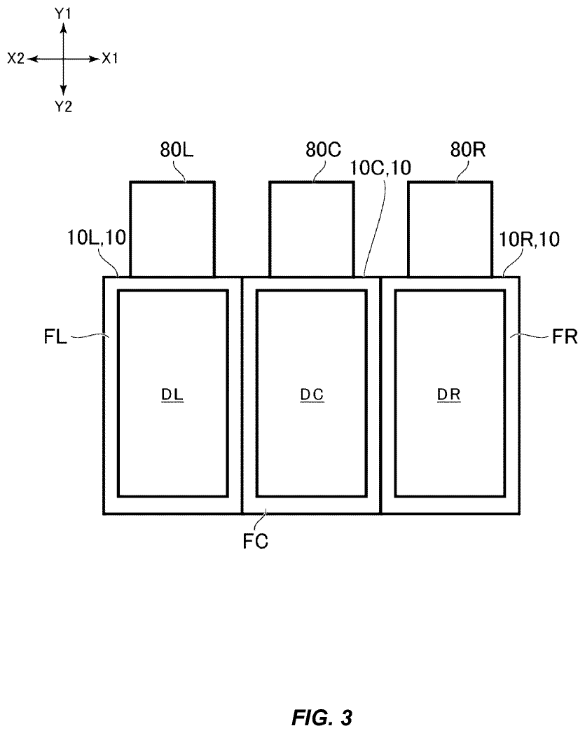

Next, the configuration of the display panel and the optical system of the present embodiment will be described in detail with reference to FIGS. 2 and 3. FIG. 2 is a diagram schematically illustrating a configuration of the display panel and the optical system of the present embodiment. FIG. 3 is a plan view illustrating the display panel of the present embodiment as seen from the front. FIG. 2 illustrates the display panel and the optical system, on either the right eye side or the left eye side of a user U, however, the configuration illustrated in FIG. 2 may acceptably be provided on both the right eye side and the left eye side. However, such is not limited to a compound lens, and may be a single lens.

### Eyepiece Lens 200

An eyepiece lens 200 constitutes one portion of the optical system of the HMD 1. The eyepiece lens 200 is a convex lens that is positioned in front of the right or left eye of the user U in the utilized state, and focuses image light IL exiting the display panel 10 in the direction of the eyeball of the user U. The eyepiece lens 200 has a function of enlarging an image displayed on the display panel 10 for the user to observe. Note that the eyepiece lens 200 may be configured of two or more lenses. In addition, the eyepiece lens 200 may be a Fresnel lens or a liquid crystal lens.

In FIG. 2, an optical axis 200C of the eyepiece lens 200 is indicated by a dashed line. The optical axis is a virtual axis, which passes through the center of the lens and is perpendicular to the surface of the lens.

### Display Unit 100

The display unit 100 includes a plurality of the display panel 10 and a plurality of lens portions 20, which are provided respectively corresponding to the plurality of display panels 10. In the present embodiment, one example will be described in which the plurality of display panels 10 are: a front panel 10C, a right panel 10R, and a left panel 10L. The front panel 10C, the right panel 10R, and the left panel 10L may be, for example, micro OLEDs of 0.49 inches or smaller. By aligning three of the 0.49-inch (2K) micro OLEDs side by side, the appearance of a 1.5-inch (6K)-equivalent micro OLED can be achieved. The cost when utilizing three 0.49-inch micro OLEDs is approximately one-tenth that of utilizing one 1.5-inch micro OLED.

In addition, an example will be described in which the plurality of lens portions 20 of the present embodiment are: a front lens portion 20C, a right lens portion 20R, and a left lens portion 20L. The lens portion 20 is configured of the eyepiece lens 200 along with the optical system. The lens portion 20 is arranged in front of the display panel 10 and is not in contact with the display panel 10. An interval may be appropriately set between the lens portion 20 and the display panel 10 so as to obtain a desired focal length. Note that the distance between the center of the right lens portion 20R and the center of the right panel 10R may be greater than the distance between the center of the front lens portion 20C and the center of the front panel 10C. Similarly, the distance between the center of the left lens portion 20L and the center of the left panel 10L may be greater than the distance between the center of the front lens portion 20C and the center of the front panel 10C. This makes it possible to improve aberration. Note that the center of the right lens portion 20R is the part facing the right panel 10R, and an optical axis OR passes therethrough; and the center of the right panel 10R is the part facing the right lens portion 20R, and is centrally positioned in the up-down and left-right directions. Similarly, the center of the left lens portion 20L is the part facing the left panel 10L, and an optical axis OL passes therethrough; and the center of the left panel 10L is the part facing the left lens portion 20L, and is centrally positioned in the up-down and left-right directions.

Note that in the present embodiment, the front panel 10C, the right panel 10R, and the left panel 10L are simply referred to as the “display panels 10” when there is no need to distinguish therebetween for description. Similarly, the front lens portion 20C, the right lens portion 20R, and the left lens portion 20L are simply referred to as the “lens portions 20” when there is no need to distinguish therebetween for description.

### Display Unit 100: Display Panel 10

As illustrated in FIG. 3, the front panel 10C includes a display area DC and a frame area FC that encloses the display area DC. The display area DC is an area that includes a plurality of unit pixels, and is an area for displaying an image. The frame area FC is an area wherein no image is displayed.

As illustrated in FIG. 2, the front panel 10C is provided in front of the eyepiece lens 200. Specifically, the front panel 10C is provided on an extension of the line of the optical axis 200C for the eyepiece lens 200.

As illustrated in FIG. 3, the right panel 10R includes a display area DR and a frame area FR that encloses the display area DR. The display area DR is an area that includes a plurality of pixels, and is an area for displaying an image. The frame area FR is an area wherein no image is displayed.

The right panel 10R is provided adjacent to the right side of the front panel 10C. Therefore, the left portion of the frame area FR of the right panel 10R and the right portion of the frame area FC of the front panel 10C are provided adjacent to each other. The right panel 10R is not provided on an extension of the line of the optical axis 200C of the eyepiece lens 200. The right panel 10R is provided facing the eyepiece lens 200 on the right-hand side of the optical axis 200C.

In addition, as illustrated in FIG. 2, in the right panel 10R, the display surface of the display area DR is provided inclined with respect to a display surface of the display area DC so that a right portion thereof approaches the eyepiece lens 200. Specifically, the display surface of the display area DR of the right panel 10R is inclined at 6.5 degrees with respect to the display surface of the display area DC of the front panel 10C. However, such is not limited thereto, and the display surface of the display area DR of the right panel 10R may be inclined at 6 to 7 degrees with respect to the display surface of the display area DC of the front panel 10C.

As illustrated in FIG. 3, the left panel 10L includes a display area DL and a frame area FL that encloses the display area DL. The display area DL is an area that includes a plurality of pixels, and is an area for displaying an image. The frame area FL is an area wherein no image is displayed.

The left panel 10L is provided adjacent to the left side of the front panel 10C. Therefore, the right portion of the frame area FL of the left panel 10L and the left portion of the frame area FC of the front panel 10C are provided adjacent to each other. The left panel 10L is not provided on an extension of the line of the optical axis 200C of the eyepiece lens 200. The left panel 10L is provided facing the eyepiece lens 200 on the left-hand side of the optical axis 200C.

In addition, as illustrated in FIG. 2, in the left panel 10L, the display surface of the display area DL is provided inclined with respect to a display surface of the display area DC so that a left portion thereof approaches the eyepiece lens 200. Specifically, the display surface of the display area DL of the left panel 10L is inclined at 6.5 degrees with respect to the display surface of the display area DC of the front panel 10C. However, such is not limited thereto, and the display surface of the display area DL of the left panel 10L may be inclined at 6 to 7 degrees with respect to the display surface of the display area DC of the front panel 10C.

Note that each display panel 10 may be a flexible panel possessing a flexibility. The flexible panels may be used, for example, for the left panel 10L and the right panel 10R, and these may be provided in a curved manner.

### Display Unit 100: Lens Portion 20

The front lens portion 20C is provided in front of the eyepiece lens 200. Specifically, the front lens portion 20C is provided on an extension of the line of the optical axis 200C for the eyepiece lens 200. Therefore, the front lens portion 20C is provided facing the front panel 10C.

The front lens portion 20C is a convex lens for guiding the image light IL exiting the display area DC to the eyepiece lens 200, and for enlarging the display area DC for the user to observe. The front lens portion 20C is provided such that an optical axis OC thereof is perpendicular to the display surface of the front panel 10C. The size of the front lens portion 20C may be approximately the same size as the front panel 10C, or of a size that covers approximately at least half of the display surface of the front panel 10C.

The right lens portion 20R is provided adjacent to the right side of the front lens portion 20C. The right lens portion 20R is provided facing the eyepiece lens 200 on the right-hand side of the optical axis 200C. The right lens portion 20R is not provided on an extension of the line of the optical axis 200C of the eyepiece lens 200.

The right lens portion 20R is a convex lens for guiding the image light IL exiting the display area DR to the eyepiece lens 200, and for enlarging the display area DR for the user to observe. The right lens portion 20R is provided such that an optical axis OR thereof is perpendicular to the display surface of the right panel 10R. Therefore, the optical axis OR is inclined with respect to the optical axis OC. Specifically, the optical axis OR of the right lens portion 20R is provided at an incline of 6.5 degrees with respect to the optical axis OC of the front lens portion 20C. The invention, however, is not limited thereto, and the optical axis OR of the right lens portion 20R may be inclined at an angle of 6 to 7 degrees with respect to the optical axis OC of the front lens portion 20C. The size of the right lens portion 20R may be approximately the same size as the right panel 10R, or of a size that covers, approximately at least half of the display surface of the right panel 10R.

The left lens portion 20L is provided adjacent to the left side of the front lens portion 20C. The left lens portion 20L is provided facing the eyepiece lens 200 on the left-hand side of the optical axis 200C. The left lens portion 20L is not provided on an extension of the line of the optical axis 200C of the eyepiece lens 200.

The left lens portion 20L is a convex lens for guiding the image light IL exiting the display area DL to the eyepiece lens 200, and for enlarging the display area DL for the user to observe. The left lens portion 20L is provided such that the optical axis OL thereof is perpendicular to the display surface of the left panel 10L. Therefore, the optical axis OL is inclined with respect to the optical axis OC. Specifically, the optical axis OL of the left lens portion 20L is provided at an incline of 6.5 degrees with respect to the optical axis OC of the front lens portion 20C. The invention, however, is not limited thereto, and the optical axis OL of the left lens portion 20L may be inclined at an angle of 6 to 7 degrees with respect to the optical axis OC of the front lens portion 20C. The size of the left lens portion 20L may be approximately the same size as the left panel 10L, or of a size that covers approximately at least half of the display surface of the left panel 10L.

An example is given in the present embodiment in which the lens portion 20 is an aspheric lens, however, the invention is not limited thereto, and use of a spherical lens or a free-form lens is acceptable. In addition, an example is given in the present embodiment in which the front lens portion 20C, the right lens portion 20R, and the left lens portion 20L are integrally configured, as illustrated in FIG. 2, however, the invention is not limited thereto, and these may be separate bodies from each other. Relative positional accuracy of the respective lens portions can be easily improved in the case that the front lens portion 20C, the right lens portion 20R, and the left lens portion 20L are integrally configured. On the other hand, in the case that the front lens portion 20C, the right lens portion 20R, and the left lens portion 20L are separate bodies, as illustrated in FIG. 2, the front lens portion 20C, the right lens portion 20R, and the left lens portion 20L may be lenses whose curved surfaces are of the same form, thereby reducing molding costs and avoiding the complexities of step management. However, the front lens portion 20C, the right lens portion 20R, and the left lens portion 20L may acceptably be of different forms.

### Display Image

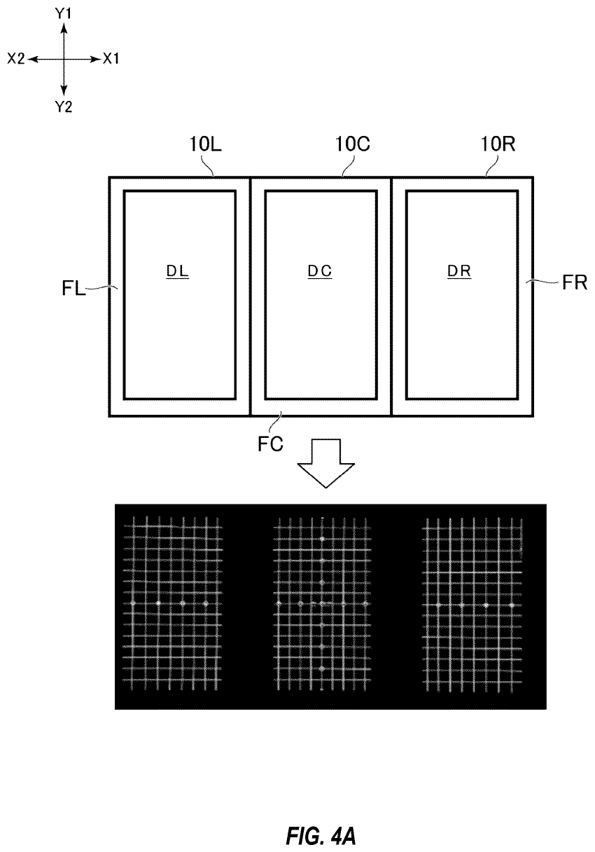

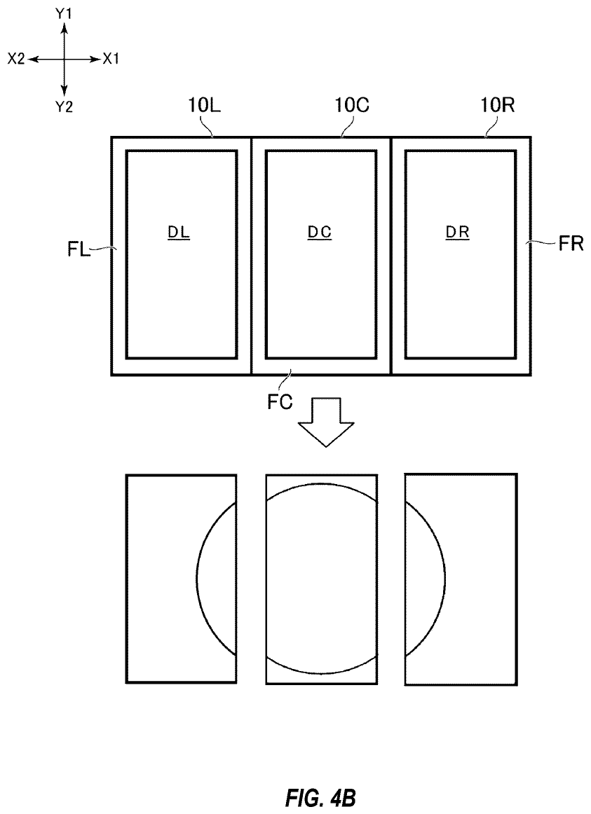

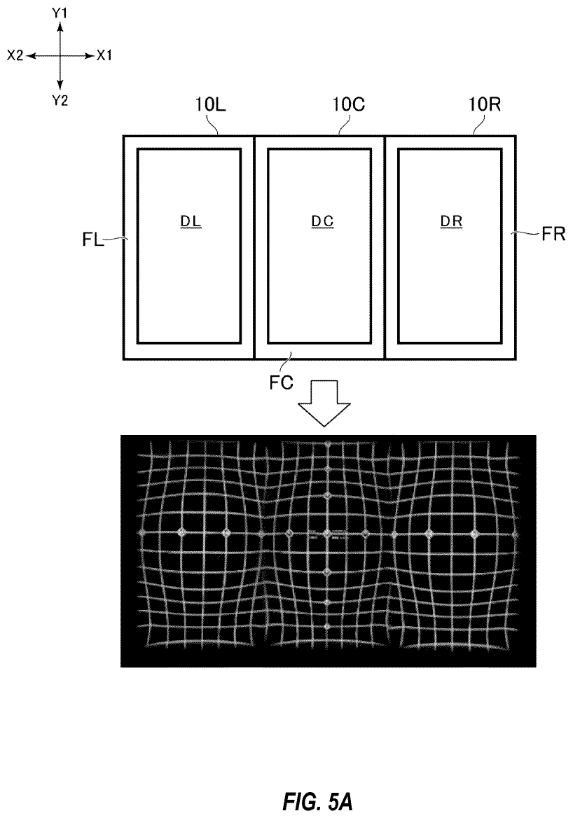

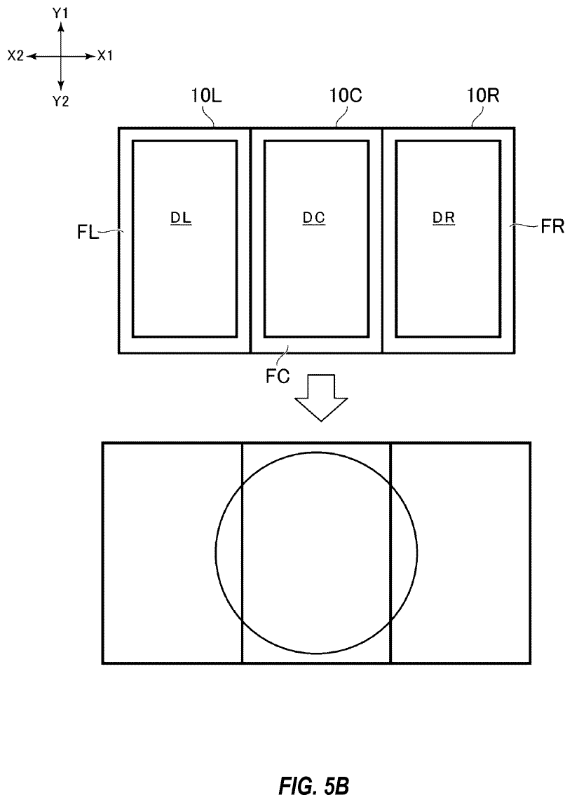

Next, with reference to FIGS. 4A to 5B, a display image of the HMD 1 of the present embodiment will mainly be described. FIG. 4A is a diagram illustrating one example of a display image when a lattice form is displayed in each display area. FIG. 4B is a diagram illustrating one example of a display image when a circular object is displayed. FIG. 5A is a diagram illustrating one example of a display image which is visible to a user through a lens portion when a lattice form is displayed in each display area. FIG. 5B is a diagram illustrating one example of a display image which is visible to a user through a lens portion when a circular object is displayed. Note that in the upper sections of FIGS. 4A to 5B, plan views (that is, the plan view illustrated in FIG. 3) are illustrated showing views as seen from in front of the display panel, and in the lower sections, display images which are visible to the user are illustrated.

The display area DC, the display area DR, and the display area DL mutually form one image. However, as described with reference to FIG. 3, each of the display panels 10 has a frame area, and as illustrated in the lower section of FIGS. 4A and 4B, one image is displayed in a disconnected manner through the frame area. That is, the image displayed by the display area DC and the image displayed by the display area DR are non-contiguous, and the image displayed by the display area DC and the image displayed by the display area DL are non-contiguous.

The lower section of FIG. 4A illustrates the respective appearances of lattice forms being displayed in each display area. As described above, due to the presence of the frame area, the lattice forms displayed by the respective display areas are visually observed as being spaced at intervals to each other.

The lower section of FIG. 4B illustrates the respective appearances of parts of a circular object being displayed in each display area. As described above, due to the presence of the frame area, a non-contiguous object is visually observed.

Therefore, in the present embodiment, a configuration is employed in which the lens portions 20 respectively correspond to each of the display panels 10. Therefore, the user U is able to visually observe the images displayed by each display area as one continuous image.

The lower section of FIG. 5A illustrates an appearance in which intervals between respective lattice points among the lattice forms are visually observed as being expanded compared to that in the lower section of FIG. 4A. Additionally, FIG. 5B illustrates an appearance in which one contiguous, circular object is visually observed. One contiguous object is visually observed as such due to the provision of each of the lens portions 20 such that the images displayed by each display area are visually observed as being expanded.

Note that by visually observing the display areas through the lens portions 20, the visual observation of the user is distorted by each of the display areas, as illustrated in the lower section of FIG. 5A. Distortion correction may be performed in this regard using electronic means. In other words, by performing distortion correction by taking into account an amount of distortion caused by the lens and displaying an image whose distortion is opposite thereto, the outer forms of the respective display areas are visually observed as a rectangle, as illustrated in the lower section of FIG. 5B.

### Summary

The HMD 1 according to the present embodiment can, using an inexpensive, small panel, enable the user to visually observe a high-resolution image at a wide angle of view. Moreover, employing a configuration in which the plurality of lens portions 20 is respectively provided corresponding to the plurality of display panels 10 enables the user to visually observe one continuous image even when a display panel 10 having a frame area is used.

Furthermore, costs, when compared to using one large display panel, can be reduced by utilizing a plurality of small display panels. The cost of purchasing a commercially available display panel can be 10 times more or greater, for example, when a display panel having twice the display area of another is used.

Generally, in an HMD requiring a wide visually observing angle, a lens that is approximately the same diameter and thickness as the eyepiece lens must be added in order to achieve a high resolution for the eyepiece lens. Due to this, HMDs are enlarged in the front-rear direction. In the present embodiment, by employing a configuration in which, in addition to the eyepiece lens 200, the plurality of lens portions 20 are arranged side by side, it is possible to shorten the focal length of the optical system without increasing the thickness of the eyepiece lens 200 or the curvature of the lens surface. Thus, provision of the HMD 1 is enabled wherein the high resolution of a displayed image being viewed is achieved without an increase in size in the front-rear direction (depth direction). Note that another lens may acceptably not be provided between the eyepiece lens 200 and the lens portion 20 in the front-rear direction.

In addition, imaging performance of the eyepiece lens 200 is higher on the side closer to the optical axis 200C thereof and is lower on the outer edge side of the eyepiece lens 200. That is, on the outer edge side of the eyepiece lens 200, the image tends to be visually observed as blurred compared to near the optical axis 200C. In the present embodiment, by employing a configuration in which the lens portions 20 are respectively provided corresponding to each display area, it is possible to improve visibility even in areas on outer edge sides of the eyepiece lens 200. Moreover, as described above, in the present embodiment, by arranging the right panel 10R and the left panel 10L inclined relative to the front panel 10C so as to approach the eyepiece lens 200, visibility can be improved, even in the areas on the outer edge sides of the eyepiece lens 200.

### Flexible Wiring Board

As illustrated in FIG. 3, each display panel 10 may be provided with flexible wiring boards 80C, 80R, and 80L for supplying image signals to these display areas. Note that the flexible wiring boards 80C, 80R, and 80L may be wiring boards for supplying power.

The flexible wiring boards 80C, 80R, and 80L may be provided extending in a direction perpendicular to the direction in which the display panels 10 are aligned (the left-right direction in the present embodiment). FIG. 3 illustrates the appearance of each flexible wiring board attached to the top of each display panel 10 and extending upward.

### First Variation

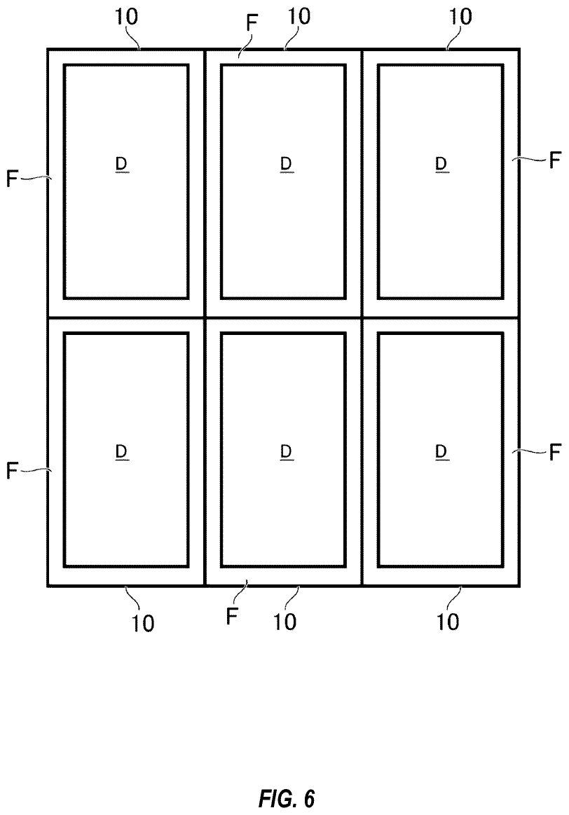

A first variation of the present embodiment will be described with reference to FIG. 6. FIG. 6 is a diagram illustrating the display panel of the first variation.

In the above embodiment, an example is described in which the display unit 100 has three of the display panels 10, however, the number of the display panels 10 is not limited thereto. For example, as illustrated in FIG. 6, the display unit 100 may acceptably have six display panels 10. In this case, as illustrated in FIG. 6, it is preferable that the respective display panels be arranged adjacent to each other in the left-right and up-down directions.

As illustrated in FIG. 6, by making the number of display panels 10 arranged in the left-right direction an odd number, display areas D of the display panels 10, which are arranged in the center in the left-right direction, may be provided on an extension of the line of the optical axis 200C of the eyepiece lens 200. However, the invention is not limited thereto, and an even number of the display panels 10 may acceptably be aligned in the left-right direction. Note that in this case, it is preferable that the display panels 10 be arranged so as to avoid arrangement of the frame area F on an extension of the line of the optical axis 200C of the eyepiece lens 200. This is because areas near an extension of the line of the optical axis 200C are areas which are most readily perceptible to the user. The user may feel a strong sense of discomfort in the case that the frame area F is arranged on an extension of the line of the optical axis 200C and the seams of the visually observed images do not match.

Note that, for the display panels 10 and the lens portions 20, the numbers thereof are not limited to the examples illustrated in FIGS. 2 and 6. A plurality of the display areas D, at least, are provided, and the number of the lens portions 20 may be the same as the number of the display areas D.

### Second Variation

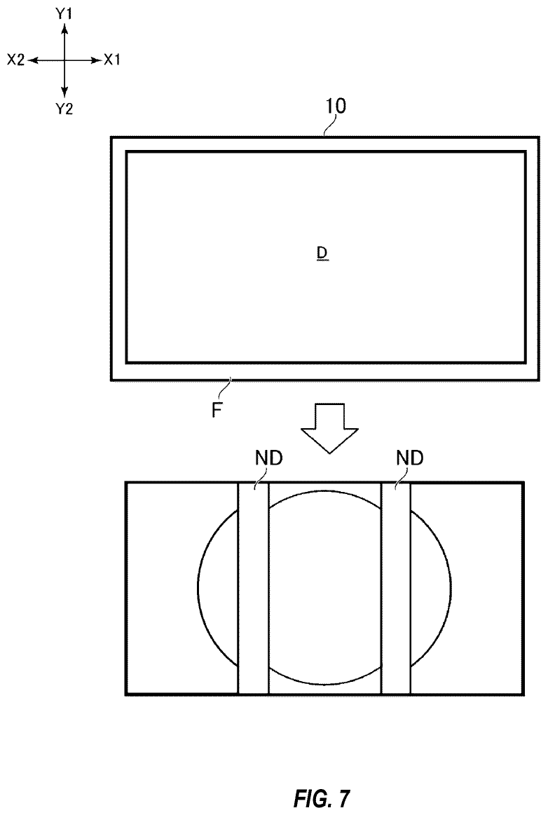

A second variation of the present embodiment will be described with reference to FIG. 7. FIG. 7 is a diagram illustrating the display panel of the second variation. Note that the upper section of FIG. 7 illustrates one of the display panel 10, and the lower section of FIG. 7 illustrates a display area D as visually observed without passing through the lens portion 20.

In the above embodiment and first variation, an example is given in which the display unit 100 contains a plurality of the display panels 10, but there may acceptably be one of the display panels 10.

Even in the case that one display panel 10 is used, visibility on the outer edge sides of the eyepiece lens 200 may be improved by employing a configuration in which a plurality of the lens portions 20 is provided. Here, in a configuration in which the plurality of lens portions 20 is provided facing the one display panel 10 and aligned in the left-right direction, the display areas D are visually observed as enlarged due to the lens portions 20, resulting in a perceptible overlap of one portion of the display area D. Therefore, in the second variation, an area in the display areas D in which no image is displayed may be provided instead of the frame area F. Specifically, as illustrated in FIG. 7, non-display areas ND may be provided. Thereby, a plurality of display areas displaying a non-contiguous image through the non-display areas ND is formed. Alternatively, the same image may be displayed in the part of the display areas D which is visually observed as overlapping through the lens portion 20.

### Addition

For example, the head-mounted display may be configured as follows.

(1) A head-mounted display worn on the head of a user, including:
an eyepiece lens positioned in front of the eye of the user in the state wherein the user is wearing the head-mounted display;
a display panel including at least a first display area for displaying a first image and a second display area for displaying a second image non-contiguously from the first image;
a first lens portion for guiding first image light exiting the first display area to the eyepiece lens and enlarging the first image for the user to observe; and
a second lens portion for guiding second image light exiting the second display area to the eyepiece lens and enlarging the second image for the user to observe.

(2) The head-mounted display according to (1), wherein the display panel further includes, at least:
the first display area and a first display panel including a first frame area that encloses the first display area, as well as the second display area and a second display panel including a second frame area that encloses the second display area,
the first lens portion being provided facing the first display panel, and
the second lens portion being provided facing the second display panel.

(3) The head-mounted display according to (1) or (2), wherein the display panel further includes:
a front panel including the first display area and the first frame area that encloses the first display area;
a right panel, adjacent to the front panel on the right side, including the second display area and the second frame area that encloses the second display area; and
a left panel, adjacent to the left side of the front panel, including a third display area and a third frame area that encloses the third display area;
wherein,
the first lens portion is provided facing the front panel, and
the second lens portion is provided facing the right panel;
the head-mounted display further including:
a third lens portion provided facing the left panel, wherein third image light exiting the third display area is guided to the eyepiece lens and the third display area is enlarged for the user to observe.

(4) The head-mounted display according to (3), wherein
the front panel is provided on an extension of the line of the optical axis of the eyepiece lens,
in the right panel, a display surface of the second display area is provided inclined with respect to the display surface of the first display area so that the right portion approaches the eyepiece lens, and
in the left panel, a display surface of the third display area is provided inclined with respect to the display surface of the first display area so that the left portion approaches the eyepiece lens.

(5) The head-mounted display according to (4), wherein
the second lens portion and the third lens portion are provided so that the optical axes thereof are inclined with respect to the optical axis of the first lens portion.

(6) The head-mounted display according to any of (3) to (5), wherein
the first display area is provided on an extension of the line of the optical axis of the eyepiece lens.

(7) The head-mounted display according to any of (3) to (6), wherein
the distance between the center of the second lens portion and the center of the right panel is longer than the distance between the center of the first lens and the center of the front panel, and
the distance between the center of the third lens portion and the center of the left panel is longer than the distance between the center of the first lens portion and the center of the front panel.

(8) The head-mounted display according to any of (1) to (7), wherein
the display panel further includes a plurality of display panels aligned in the left-right directions,
with the display panel arranged in the center in the left-right directions among the plurality of display panels being provided on an extension of the line of the optical axis of the eyepiece lens.

(9) The head-mounted display according to any of (1) to (8), wherein
the display panel further includes, at least: the first display area and a first display panel including a first frame area that encloses the first display area, as well as the second display area and a second display panel including a second frame area that encloses the second display area, and,
in the first display panel and the second display panel, the first frame area and the second frame area are provided overlapping the extension of the line of the optical axis of the eyepiece lens.

(10) The head-mounted display according to any of (1) to (9), wherein the first lens portion and the second lens portion are not in contact with the display panels.

(11) The head-mounted display according to any of (1) to (10), further including:
a first flexible wiring board for supplying a first image signal to the first display area; and
a second flexible wiring board for supplying a second image signal to the second display area, wherein
the first flexible wiring board and the second flexible wiring board are provided extending in the direction orthogonal to the direction in which the first display area and the second display area are aligned.

### DESCRIPTION OF REFERENCE NUMERALS

1 Head-mounted display, 10 display panel, 20 lens portion, 200 eyepiece lens.

1.-11. (canceled)

12. A head-mounted display configured to be worn on a head of a user, the head-mounted display comprising:
an eyepiece lens positioned in front of the user in when the user is wearing the head-mounted display;
a display panel comprising at least a first display area for displaying a first image and a second display area for displaying a second image, the second image being displayed in a non-contiguous manner from the first image;
a first lens portion configured for guiding first image light emanating from the first display area to the eyepiece lens and enlarging the first image for observation by the user; and
a second lens portion configured for guiding second image light emanating from the second display area to the eyepiece lens and enlarging the second image for observation by the user.

13. The head-mounted display of claim 12, further comprising:
a first frame area enclosing the first display area; and
a second frame area enclosing the second display area,
wherein the first lens portion is disposed facing the first display area, and
wherein the second lens portion is disposed facing the second display area.

14. The head-mounted display of claim 13, further comprising:
a front panel comprising the first display area and the first frame area;
a right panel, adjacent to a right side of the front panel, the right panel comprising the second display area and the second frame area;
a left panel, adjacent to a left side of the front panel, the left panel comprising a third display area and a third frame area configured to enclose the third display area, the third display area being configured for displaying a third image, the third image being displayed in a non-contiguous manner from the first and second images; and
a third lens portion configured for guiding third image light emanating from the third display area to the eyepiece lens and enlarging the third image for observation by the user,
wherein,
the first lens portion is disposed facing the front panel,
the second lens portion is disposed facing the right panel, and
the third lens portion is disposed facing the left panel.

15. The head-mounted display of claim 14, wherein:
the front panel is disposed along an extension of an optical axis of the eyepiece lens,
in the right panel, the second display area is inclined with respect to the first display area such that the right panel approaches the eyepiece lens, and
in the left panel, the third display area is inclined with respect to the first display area such that the left panel approaches the eyepiece lens.

16. The head-mounted display of claim 15, wherein:
a first optical axis of the first lens portion is aligned with the optical axis of the eyepiece lens,
a second optical axis of the second lens portion and a third optical axis of the third lens portion are inclined with respect to the first optical axis of the first lens portion.

17. The head-mounted display according to claim 14, wherein:
the first display area is disposed along an extension of an optical axis of the eyepiece lens.

18. The head-mounted display of claim 14, wherein:
a first distance between a center of the first lens and a center of the front panel is shorter than a second distance between a center of the second lens portion and a center of the right panel, and
the first distance is shorter than a third distance between the center of the third lens portion and the center of the left panel.

19. The head-mounted display of claim 13, wherein:
the first frame area and the second frame area are disposed to overlap an extension of an optical axis of the eyepiece lens.

20. The head-mounted display of claim 12, wherein:
the display panel further comprises a plurality of display panels aligned in left-right directions, and
a center display panel of the plurality of display panels is disposed on an extension of an optical axis of the eyepiece lens.

21. The head-mounted display of claim 12, wherein:
the first lens portion is spaced apart from the first display area, and
the second lens portion is spaced apart from the second display area.

22. The head-mounted display of claim 12, further comprising:
a first flexible wiring board for supplying a first image signal to the first display area; and
a second flexible wiring board for supplying a second image signal to the second display area,
wherein:
the first display area and the second display area being aligned in a first direction, and
each of the first flexible wiring board and the second flexible wiring board extends in a second direction orthogonal to the first direction.
